(19) United States
(12) Patent Application Publication
(10) Pub. No.: US 2018/0344125 A1
(43) Pub. Date: Dec. 6, 2018

(54) ROTATABLE VIBRATION MOP

(71) Applicant: I-Chang CHEN, New Taipei City (TW)

(72) Inventors: I-Chang CHEN, New Taipei City (TW); Hsuan-Hao HSU, Taipei City (TW); Tsuan-Hung CHEN, Taipei City (TW)

(21) Appl. No.: 15/802,294

(22) Filed: Nov. 2, 2017

(30) Foreign Application Priority Data
Jun. 6, 2017 (TW) 106208098

(51) Int. Cl. A47L 13/24; H02N 2/00

(52) U.S. Cl. CPC A47L 13/24; H04W 4/008; H02N 2/001

(57) ABSTRACT

A rotatable vibration mop is provided. The rotatable vibration mop includes a first rod, a connection element and a rotatable cleaning assembly. The first rod includes a wireless signal transmitter. The rotatable cleaning assembly includes a second rod and a dismountable cleaning component. The connection element connects the first rod and the second rod for the rotatable cleaning assembly to be rotatable with respect to the first rod. The dismountable cleaning component connects with the second rod in a dismountable way, and includes a cleaning body, a wireless signal receiver and a vibrator. The wireless signal receiver and the vibrator are disposed on the cleaning body, and connected with each other electrically. The wireless signal transmitter transmits a signal to the wireless signal receiver to switch on/off the vibrator.

### PRIORITY CLAIM

This application claims priority to Taiwan Patent Application No. 106208098 filed on Jun. 6, 2017, which is hereby incorporated by reference in its entirety.

### CROSS-REFERENCES TO RELATED APPLICATIONS

Not applicable.

### BACKGROUND OF THE INVENTION

### Field of the Invention

The present invention relates to a rotatable vibration mop. More particularly, the present invention relates to a mop capable of rotatably dewatering and also having a vibration function.

### Descriptions of the Related Art

In recent years, many mops are designed to be of a two-segment structure including a handle end and a cleaning end. By rotating the cleaning end at a high speed relative to the handle end, the cleaning end that has absorbed excessive water therein can be dewatered conveniently by the user to increase efficiency of the cleaning operation. On the other hand, some mops also have a structure in which a vibrator is disposed at the cleaning end and a vibrator switch is disposed at the handle of the mop to improve the cleaning strength. However, these two designs cannot coexist.

In detail, in the mop having a vibrator, the switch at the handle and the vibrator at the cleaning end still need to be connected by a physical cable, so the cable wound be excessively wounded or pulled to cause fracture of the cable if the handle is rotated at a high speed relative to the cleaning end.

Accordingly, an urgent need exists in the art to combine the advantages of the two kinds of structures to improve both the convenience in use and the cleaning strength.

### SUMMARY OF THE INVENTION

The primary objective of the present invention is to provide a rotatable vibration mop, which comprises a first rod, a connection element and a rotatable cleaning assembly. The first rod has a wireless signal transmitter disposed thereon. The rotatable cleaning assembly comprises a second rod and a dismountable cleaning component. The dismountable cleaning component connects with the second rod in a dismountable way. The connection element connects the first rod and the second rod for the rotatable cleaning assembly to be rotatable with respect to the first rod.

Further speaking, the dismountable cleaning component comprises a cleaning body, a wireless signal receiver and at least one vibrator. The wireless signal receiver and the at least one vibrator are disposed on the cleaning body and electrically connected with each other. The wireless signal transmitter transmits a signal to the wireless signal receiver to switch on/off the at least one vibrator.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a front view of a rotatable vibration mop according to the present invention;

FIG. 2 is a partial front view of a rotatable cleaning assembly according to the present invention;

FIG. 3 is a perspective view of a dismountable cleaning component according to the present invention;

FIG. 4 is a partial cross-sectional view of a first rod according to the present invention;

FIG. 5 is a bottom cross-sectional view of a dismountable cleaning component according to the present invention; and

FIG. 6 is another perspective view of the dismountable cleaning component according to the present invention.

### DESCRIPTION OF THE PREFERRED EMBODIMENT

In the following description, the present invention will be explained with reference to embodiments thereof. It shall be appreciated that, these embodiments are not intended to limit the present invention to any specific environment, applications or particular implementations described in these embodiments. Therefore, description of these embodiments is only for purpose of illustration rather than to limit the present invention, and the scope of this application shall be governed by the claims. Besides, in the following embodiments and the attached drawings, elements unrelated to the present invention are omitted from depiction; and dimensional relationships among individual elements in the attached drawings are illustrated only for ease of understanding, but not to limit the actual scale.

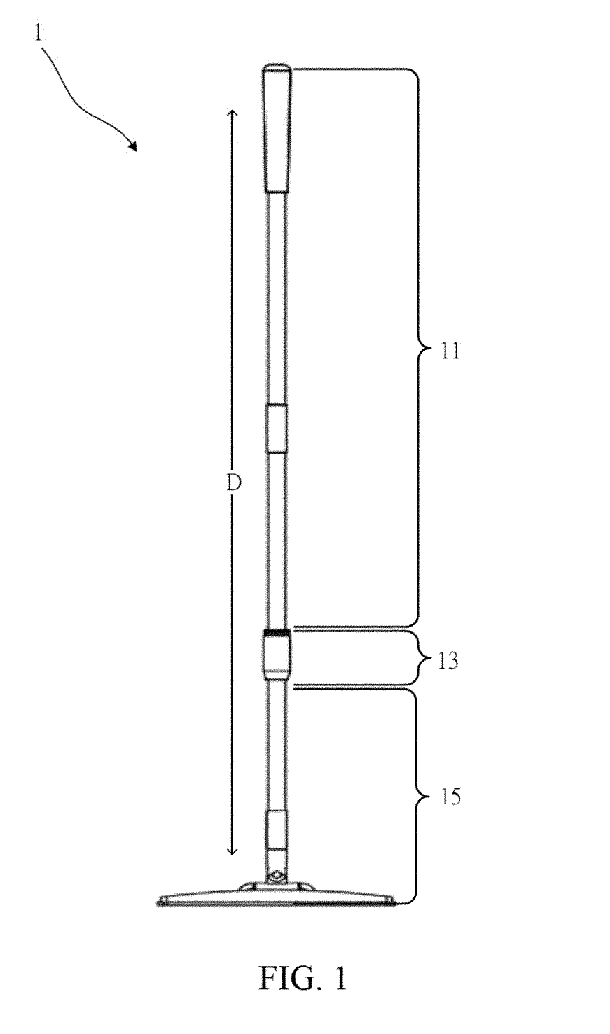

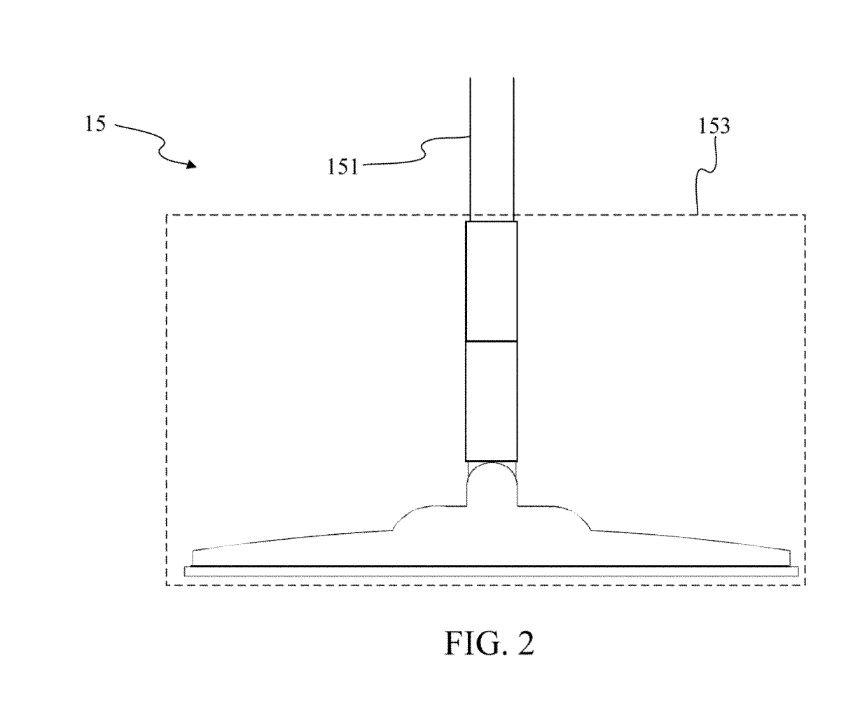

Please refer to FIGS. 1-2. FIG. 1 is a front view of a rotatable vibration mop 1 according to the present invention. The rotatable vibration mop 1 comprises a first rod 11, a connection element 13 and a rotatable cleaning assembly 15. FIG. 2 is a partial front view of the rotatable cleaning assembly 15 according to the present invention. The rotatable cleaning assembly 15 comprises a second rod 151 and a dismountable cleaning component 153. The connection element 13 is used to connect the first rod 11 and the second rod 151 for the rotatable cleaning assembly 15 to be rotatable with respect to the first rod 11.

In detail, the second rod 151 of the rotatable cleaning assembly 15 connects with the first rod 11 via the connection element 13, and the first rod 11 and the second rod 151 have a same axis D. Therefore, when a rotational degree of freedom between the first rod 11 and the second rod 151 can be provided by the connection element 13, the second rod 151 can rotate about the axis D with respect to the first rod 11 and, meanwhile, drive the rotatable cleaning assembly 15 to rotate relative to the first rod 11.

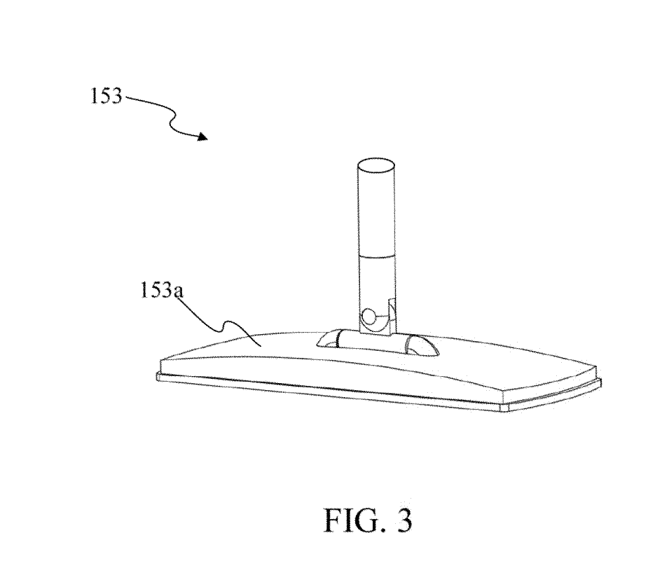

Please refer to FIG. 3 together, which is a perspective view of a dismountable cleaning component 153 according to the present invention. The dismountable cleaning component 153 comprises a cleaning body 153a. The cleaning body 153a has an element for absorbing water and for cleaning. Then when the rotatable cleaning assembly 15 is rotated at a high speed relative to the first rod 11 via the connection element 13, the excessively absorbed water can be removed by the inertia force from the cleaning body 153a to achieve the purpose of dewatering.

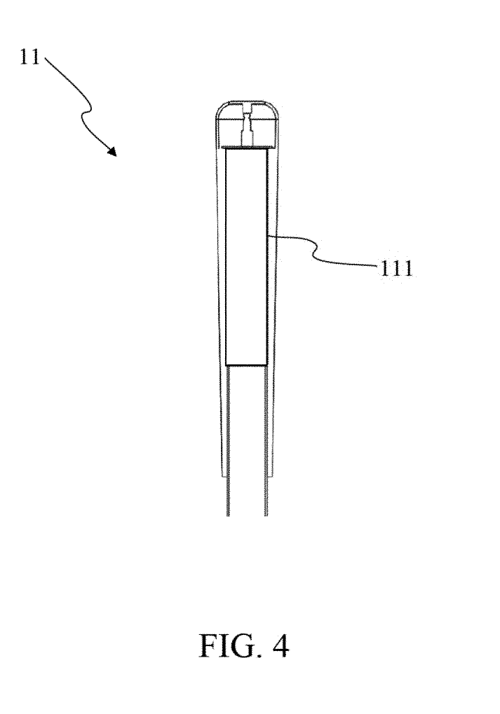

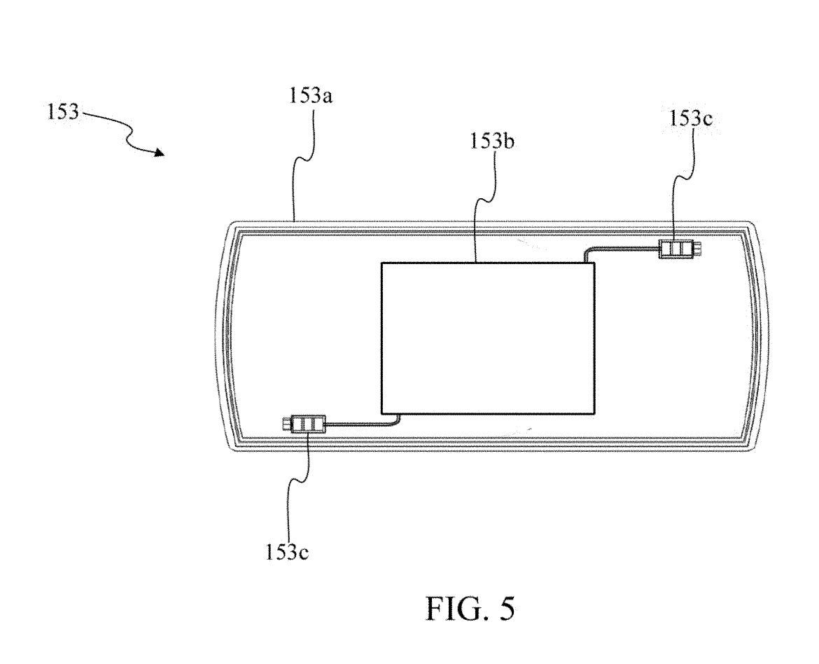

Referring next to FIGS. 4-5 together. FIG. 4 is a partial cross-sectional view of a first rod 11 according to the present invention. The first rod 11 comprises a wireless signal transmitter 111. FIG. 5 is a bottom cross-sectional view of a dismountable cleaning component 153 according to the present invention. The dismountable cleaning component 153 further comprises a wireless signal receiver 153b and at least one vibrator 153c. The wireless signal receiver 153b and the at least one vibrator 153c are both disposed on the cleaning body 153a and electrically connected with each other.

Specifically, when the wireless signal transmitter 11 of the first rod 11 is triggered by the user, a signal (not shown) is transmitted by the wireless signal transmitter 11 to the wireless signal receiver 153b of the dismountable cleaning component 153. After the signal is received by the wireless signal receiver 153b, the at least one vibrator 153c is triggered to be switched on or off. Thereby, when the at least one vibrator 153c is switched on, the at least one vibrator 153c will vibrate to significantly improve the cleaning strength of the cleaning body 153a.

It shall be particularly noted that, the first rod 11 and the dismountable cleaning component 153 may each have a power source module configured to supply power necessary for signal transmission, signal receiving and vibration of the wireless signal transmitter 11, the wireless signal receiver 153b and the vibrator 153c respectively. The power source module may be implemented by general batteries or by built-in rechargeable batteries.

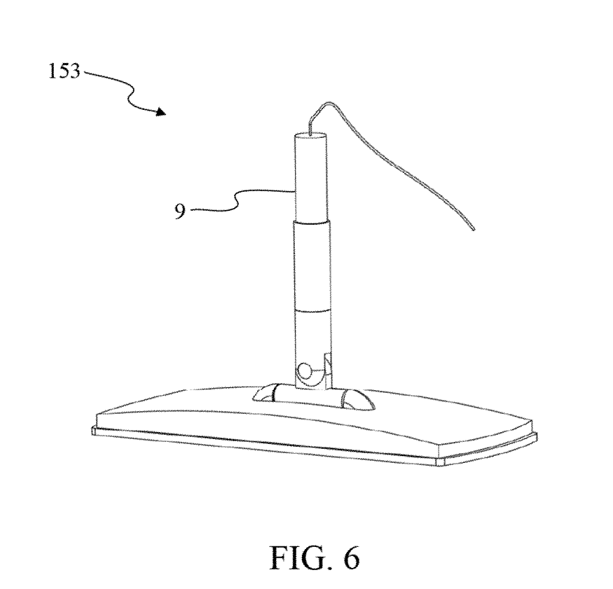

For example, please refer to FIG. 6, which is another perspective view of the dismountable cleaning component 153 according to the present invention. Specifically, the dismountable cleaning component 153 further comprises a rechargeable battery (not shown) configured to supply power to the wireless signal receiver 153b and the vibrator 153c. The rechargeable battery may be charged by a charging power source 9 via an interface between the dismountable cleaning component 153 and the second rod 151 after the dismountable cleaning component 153 is dismounted from the second rod 151.

In different implementations, the dismountable cleaning component 153 may connect with the second rod 151 through magnetic attraction or through thread engagement, and signal transmission between the wireless signal transmitter 111 and the wireless signal receiver 153b may be accomplished through Bluetooth transmission or infrared transmission. Furthermore, the number of vibrators 153c may be increased optionally. However, this is not intended to limit the implementations of the present invention.

According to the above descriptions, in the rotatable vibration mop of the present invention, the switch at the handle controls the vibrator at the cleaning end to be switched on or off through wireless signal transmission. This avoids use of a physical cable between the switch at the handle and the vibrator at the cleaning end. Thereby, both the vibration and the rotational dewatering functions can be accomplished to improve the cleaning strength and the efficiency simultaneously.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A rotatable vibration mop, comprising:
a first rod, comprising:
a wireless signal transmitter, being disposed on the first rod;
a rotatable cleaning assembly, comprising:
a second rod; and
a dismountable cleaning component, connecting with the second rod in a dismountable way, and comprising:
a cleaning body;
a wireless signal receiver, being disposed on the cleaning body; and
at least one vibrator, being disposed on the cleaning body and electrically connected with the wireless signal receiver; and
a connection element, connecting the first rod and the second rod for the rotatable cleaning assembly to be rotatable with respect to the first rod;
wherein the wireless signal transmitter transmits a signal to the wireless signal receiver to switch on/off the at least one vibrator.

2. The rotatable vibration mop according to claim 1, wherein transmission of the signal between the wireless signal transmitter and the wireless signal receiver is accomplished through infrared transmission.

3. The rotatable vibration mop according to claim 1, wherein transmission of the signal between the wireless signal transmitter and the wireless signal receiver is accomplished through Bluetooth transmission.

4. The rotatable vibration mop according to claim 1, wherein the dismountable cleaning component connects with the second rod through magnetic attraction.

5. The rotatable vibration mop according to claim 1, wherein the dismountable cleaning component connects with the second rod through thread engagement.

6. The rotatable vibration mop according to claim 1, wherein the dismountable cleaning component further comprises a rechargeable battery.
